(19) United States
(12) Patent Application Publication
(10) Pub. No.: US 2006/0141124 A1
(43) Pub. Date: Jun. 29, 2006

(54) Addition of comminuted meat trimmings to meat muscles

(75) Inventor: Timothy D. Schnell, Sun Prairie, WI (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 11/025,572

(22) Filed: Dec. 29, 2004

(51) Int. Cl. A23B 4/023

(52) U.S. Cl. 426/652

(57) ABSTRACT

A method of incorporating fat-containing meat trimmings into cuts of lean meat. Comminuted fat or meat trimmings are comminuted to form fine particles without the use of a brine or pickle solution. The fine particles are then mixed or tumbled cuts of lean meat. The fat or meat trimmings are thereby incorporated into the meat and dispersed throughout. This process may be used to incorporate added fat to cuts of meat to enhance the flavor, tenderness, and moistness of the meat product while maintaining the pleasing texture, appearance, and consistency of lean, trimmed meat.

### FIELD OF THE INVENTION

This invention relates to a method of adding fat to meats to enhance the flavor, tenderness, and moistness of the meat while maintaining the pleasing texture, consistency, and visual appearance of lean, trimmed meat. This invention is especially adapted for preparing lean meat products such as ham, turkey, chicken, roast, or corned beef.

### BACKGROUND OF THE INVENTION

Cuts of meat such as pork, beef, and chicken naturally contain fat deposits that, while favorably enhancing the meat's flavor, tenderness, and moistness, often provide an undesirable appearance and texture. Since fat deposits are not uniformly distributed throughout the meat, certain sections of a cut of meat could be composed of almost pure fat, which would provide an undesirable consistency, appearance, and flavor. For this reason, meat is ordinarily trimmed to remove excess fat from the leaner muscle tissue. The trimmings removed from the muscle tissue may have a wide range of fat content. Trimmed meat has a more desirable texture and appearance, but is more expensive because of its higher content of muscle tissue.

However, as mentioned above, the fatty deposits from meat do have several beneficial properties, such as enhancing flavor, tenderness, and moistness. Higher fat content may further enhance the meat's cooking properties for certain applications. Therefore, it is desirable to add some of the fat that is trimmed from lean muscle back into the muscle so that it is more evenly distributed so that the flavor, tenderness, moistness, and overall palatability of trimmed meat may be enhanced without adversely affecting the texture and appearance of the meat. Such a process will also, by incorporating low-cost meat trimmings into more expensive cuts of meat, decrease the cost per pound.

Prior methods of incorporating trimmings into meat have involved injection of an emulsion containing meat trimmings into meat muscle. Unfortunately, the injected emulsion of trimmings is often visible to the naked eye, and its consistency and texture may also be noticeable. In U.S. Pat. No. 4,960,599 to Cozzini et al., trimmings containing 10-50% fat are ground to a particle size of approximately ⅜ inch to 1/16 inch, frozen, and blended together with brine or brine combined with a pickle solution at a ratio of two to four parts brine and pickle solution to one part meat trimmings. The resulting emulsion is then injected into meat via a hollow needle. The meat may then be massaged or tumbled in order to more evenly disperse the injected solution. This process, however, can leave visible marks in the meat from the injection process, and requires mixing the trimmings with brine or a brine and pickle solution.

U.S. Pat. No. 5,142,971 to Norrie provides a specialized multi-needle injection apparatus. This apparatus makes the injection of meat emulsions into sections of meat less visible by utilizing a plurality of needles to inject a suspension of finely divided meat pieces suspended in a brine or pickle solution.

U.S. Pat. No. 5,989,601 to Bodenas et al. shows the injection of fermented meat trimmings into pieces of meat. Trimmings are ground to particles less than 30 millimeters in diameter, preferably 2-4 millimeters. The particles are then fermented using bacteria and then frozen, flaked, and added to a brine, pickle, or marinate solution. The resulting suspension is then injected into whole pieces of meat.

These prior methods all involve suspending particles of meat trimmings in a brine, pickle, and/or marinate solution which is ultimately injected into the meat. Injection of such an emulsion may noticeably alter the consistency of the meat, because the injected emulsion will be substantially localized to a shaft burrowed through the muscle by the hollow syringe used to inject the emulsion. In many cases, the injections may even be visible to the naked eye. The sodium content of brine, pickle, and marinate solutions may also cause myofibrillar protein extraction from the trimmings, leading to graying or lightening of the lean portion of the injected trimmings.

Therefore, it is desired to provide a method of adding meat trimmings to whole cuts of leaner meat via a process that does not involve injecting an emulsion of meat trimmings suspended in a brine, pickle, or marinate. It is also desired to provide a method of incorporating meat trimmings into meat that will not be noticeable and that will not adversely affect the flavor or texture of the meat. The present invention provides such methods.

### SUMMARY OF THE INVENTION

The present invention provides a method of adding comminuted fat or meat trimmings to cuts of meat comprising comminuting the fat or trimmings into fine particles and mixing or tumbling the comminuted particles with the lean cuts of meat. The comminuted fat or meat trimmings are prepared without the use of a brine or pickle solution. The fat or meat trimmings are thereby incorporated into, and dispersed evenly between and throughout the meat muscle tissue. This process may be used to incorporate undetectable fat into cuts of meat in order to enhance flavor, tenderness, and moistness while maintaining the pleasing texture and consistency of lean, trimmed meat.

### DETAILED DESCRIPTION

The present invention provides a method whereby fine particles of comminuted meat trimmings (prepared without the use of a brine or pickle solution) are incorporated into trimmed muscle tissue via tumbling or mixing. Through this invention, the flavor, tenderness, and moistness of meat may be improved by the addition of fat, without the undesirable texture normally associated with large fat particles (i.e., greater than about 5 mm in their longest dimension). For the purposes of this patent, “trimmings” or “trim” refer to meat trimmings comprising from about 0% lean and 100% fat to about 90% lean and 10% fat. These trimmings may comprise pork fat, beef fat, chicken fat, chicken skin, turkey fat, turkey skin, or other tissues containing at least 50% fat overall. The trimmings are preferably high in fat, preferably with at least about 70% fat, more preferably at least 80% fat, and may be essentially 100% fat. Of course, for particular applications, a higher or lower percentage of fat may be desirable. The meat used may be pork, beef, poultry, or any other type of meat, as well as mixtures thereof. The trimmings incorporated into the cuts of meat may be from the same type of meat, or may be from a different type. For instance, beef trimmings may be added to whole cuts of beef or pork.

Trimmings are comminuted to reduce particle size to less than about 5 mm in diameter, preferably less than about 2 mm, and preferably less than about 1 mm. The trimmings can be comminuted alone (the preferred embodiment) or with a brine-free aqueous composition (preferably in a ratio of about 3 to about 5 parts fat to 1 part water) to provide lubricity; no brine or pickle solution should be presented while comminuting the trimmings. Any cutting, chopping, or grinding equipment may be used as long as it is capable of achieving the desired particle size. Generally, an emulsifier-type apparatus is preferred in order to create finely comminuted particles. Such emulsifier-type apparatus is used only to reduce particle size; the formation of an emulsion or suspension of comminuted trim particles is not required for this invention. Comminuting preferably takes place with a delta T (temperature rise during comminuting) of about 4 to about 20° F. (more preferably about 8 to about 15° F.), and preferably achieves a final temperature of about 40 to about, 55° F.

The trimmings are not mixed with brine either before or during comminuting or before adding to muscle tissue, since the sodium content of such brine solutions may cause premature myofibrillar extraction, and may also cause graying of the trimmings (especially for the lean portion of the trimmings) that increases visibility of the added particles in the final product. For purposes of this invention, a brine-free aqueous composition contains less than about 0.5% salt, and preferably less than about 0.05% salt. For purposes of this invention, treatment of the trimmings without the use of a brine or pickle solution is intended to mean that a brine or pickle solution containing more than about 0.5% salt is not used to comminute the trimmings to the desired size. The lean meat, into which the trimmings will be incorporated, may be injected, if desired, with a brine or pickle solution containing salt, phosphate, and/or nitrite.

The brine-free comminuted trim particles are then added to lean muscle tissue in a tumbling or mixing apparatus. Such tumbling or mixing devices include, for example, paddle mixers, ribbon mixers, tumbler mixers, and the like. The combination of meat and comminuted trim particles is tumbled or mixed for a predetermined time or until a desired homogenous distribution of the fat within the meat is achieved. Generally the tumbling and/or mixing is carried out for at least about 5 minutes, and preferably for about 0.25 to about 3 hours. The tumbler or mixer turns, massages, and folds the meat. The application of such physical force causes the comminuted particles of trimmings to be evenly distributed and absorbed into the meat due to the small particle size of the trimmings.

Although not wishing to be limited by theory, it is believed that during mixing or tumbling, comminuted fat particles become at least partially coated with salt soluble myofibrillar protein extracted from the muscle or lean tissue during mixing, which adds to the uptake of the fat particles. Fat uptake may also be aided by the melting or partial melting of fat into the muscle tissue during mixing or later cooking.

Preferably, tumbling is performed until the fat content of the meat product is increased up to 10% via this invention. More preferably, the fat content of the meat product is increased by 2-3%. Although the fat content of the meat product may be increased by more than 10% without deviating from the present invention, the added fat content will become more and more noticeable at higher concentrations. Such tumbling or mixing is generally carried out at a temperature of about 30 to about 45° F.

During tumbling or mixing, or at any time before or after the comminuted particles of trim are added to the muscle tissue, various treatments may be applied to the muscle tissue into which the comminuted trim particles are to be added. For example, the muscle may be treated with a brine, pickle, marinate, or similar solution prior to introduction of the fat particles. The muscle tissue may also be treated during or after the addition of the comminuted trimmings. For example, the meat may be cured, smoked, or cooked after the desired amount of comminuted fat has been evenly distributed in the lean muscle tissue.

Unless otherwise specified, all ratios and percentages are by weight.

### EXAMPLE 1

Ham muscle was trimmed of fat and injected with an aqueous solution containing 2% salt, 0.4% sodium phosphate, 1% sugar, and 156 ppm sodium nitrite. Pork trimmings (about 80% fat and about 20% lean meat) were mixed with water at a ratio of about 4 to 1 and processed in an emulsion mill at a delta T of 4-8° F. to produce comminuted trim particles of about 1 millimeter or less in diameter. The comminuted fat trim particles were mixed with the ham muscle in a mixer at about 38° F. for about 180 minutes. The product was then cured for two days and cooked in a water cooker. The inventive ham product contained about 4 percent fat.

Samples of the inventive ham product were evaluated by a trained panel consisting of 25 members and compared to a conventional ham product containing only about 1.5 percent fat. The added fat was not visibly noticeable or organoleptically detectable in the inventive samples even though the inventive sample contained more than 2 times the amount of fat than the comparative sample.

### EXAMPLE 2

Beef trimmings (essentially 100% fat) can be mixed with water at a ratio of about 4 fat to about 1 water and run through an emulsion mill to produce comminuted trim particles of less than 2 millimeters in diameter. The comminuted beef particles can be mixed with marinated lean whole pieces of beef in a mixer at about 35° F. for about 0.75 hours. The product could then be packaged for sale.

### EXAMPLE 3

Chicken skin and fat could be comminuted into particles of less than about 1 millimeter in diameter without the use of a brine or pickle solution and then tumbled with chickens breasts at about 35° F. for about 0.75 hours. The product could then be packaged for sale.

1. A method of increasing the fat content of a meat product, said method comprising comminuting meat trimmings containing at least about 50 percent fat into particles of less than about 5 mm in diameter, and tumbling or mixing the particles with lean meat for a time sufficient to distribute the particles throughout the lean meat to provide the meat product, wherein the comminuting is carried out in a brine-free aqueous composition, wherein the fat content of the meat product is increased by less than about 10% relative to the lean meat, and wherein the flavor, tenderness, and moistness of the meat product is improved relative to the lean meat without the undesirable texture or visual appearance normally associated with fat deposits.

2. The method of claim 1, wherein the tumbling or mixing is carried out at about 30 to about 45° F. for about 0.25 to about 3 hours.

3. The method of claim 1, wherein the lean meat comprises pork, beef, or poultry and the meat trimmings comprises pork, beef, or poultry trimmings.

4. The method of claim 1, wherein the particles are less than about 2 mm in diameter.

5. The method of claim 1, wherein the particles are less than about 1 mm in diameter.

6. The method of claim 1, wherein the meat trimmings contain at least about 70% fat.

7. The method of claim 1, wherein the meat trimmings contain at least about 80% fat.

8. A method of increasing the fat content of a meat product, said method comprising:
(a) adding a lubricant to meat trimmings;
(b) treating the meat trimmings from step (a) without the use of a brine or pickle solution to form brine-free particles of less than about 5 mm in diameter;
c) placing the brine-free particles into contact with an external surface of a piece of lean meat to form a mixture of the particles and the lean meat; and
(d) treating the mixture to distribute the brine-free particles throughout the lean meat to form the meat product,
wherein the fat content of the meat product is increased by less than about 10% relative to the lean meat, and wherein the flavor, tenderness, and moistness of the meat product is improved relative to the lean meat without the undesirable texture or visual appearance normally associated with fat deposits.

9. The method of claim 8, wherein the fat content of the meat product is increased by about 1 to about 8% relative to the lean meat.

10. The method of claim 8, wherein the fat content of the meat product is increased by about 2 to about 5% relative to the lean meat.

11. The method of claim 8, wherein the distribution of the brine-free particles throughout the lean meat is carried out by tumbling or mixing the particles and lean meat at a temperature of about 30 to about 45° F. for about 0.25 to about 3 hours.

12. The method of claim 11, wherein the lean meat comprises pork, beef, or poultry and the meat trimmings comprises pork, beef, or poultry trimmings.

13. The method of claim 12, wherein the particles are less than about 2 mm in diameter.

14. The method of claim 12, wherein the particles are less than about 1 mm in diameter.

15. The method of claim 8, wherein the lean meat comprises pork.

16. The method of claim 13, wherein the lean meat comprises pork.

17. The method of claim 14, wherein the lean meat comprises pork.

18. A meat product having increased levels of fat distributed therein, said meat product being a method comprising comminuting meat trimmings containing at least about 50 percent fat into particles of less than about 5 mm in diameter without the use of a brine or pickle solution, and tumbling or mixing the particles with lean meat for a time sufficient to distribute the particles throughout the lean meat to provide the meat product, wherein the fat content of the meat product is increased by less than about 10% relative to the lean meat, and wherein the flavor, tenderness, and moistness of the meat product is improved relative to the lean meat without the undesirable texture or visual appearance normally associated with fat deposits.

19. The meat product of claim 18, wherein the tumbling or mixing is carried out at about 30 to about 45° F. for about 0.25 to about 3 hours and the lean meat comprises pork, beef, or poultry and the meat trimmings comprises pork, beef, or poultry trimmings.

20. The meat product of claim 19, wherein the particles are less than about 2 mm in diameter.

21. The meat product of claim 19, wherein the particles are less than about 1 mm in diameter.
